(19) United States
(12) Patent Application Publication
(10) Pub. No.: US 2004/0120713 A1
(43) Pub. Date: Jun. 24, 2004

(54) Method and apparatus for providing sparing capacity for optical switches

(76) Inventors: Robert Ward, Sunnyvale, CA (US); Babu Narayanan, San Jose, CA (US)

Correspondence Address: JOHN C. GORECKI, ESQ., 165 HARVARD ST., NEWTON, MA, 02460, US

(21) Appl. No.: 10/383,436

(22) Filed: Mar. 7, 2003

Related U.S. Application Data
(60) Provisional application No. 60/368,019, filed on Mar. 27, 2002.

(51) Int. Cl. H04J 14/00

(52) U.S. Cl. 398/45

(57) ABSTRACT

Apparatus and methods are disclosed for providing sparing capacity for an optical switch. Apparatus is disclosed comprising: a set of primary mirrors selectively configurable within the optical switch so as to selectively facilitate a plurality of optical connections thereacross; and at least one secondary mirror selectively configurable within the optical switch so as to selectively facilitate at least one spare optical connection thereacross. A method is disclosed for providing sparing capacity for an optical switch, the method comprising: substituting one of at least one spare optical connection selectively facilitated across at least one secondary mirror for one of a plurality of optical connections selectively facilitated across a set of primary mirrors.

### REFERENCE TO RELATED APPLICATION

This patent application claims benefit of pending prior U.S. Provisional Patent Application Serial No. 60/368,019, filed Mar. 8, 2002 by Robert R. Ward et al. for SPARING METHODS FOR OPTICAL CROSS-CONNECTS AND OPTICAL SWITCHES, which patent application is hereby incorporated herein by reference.

### FIELD OF THE INVENTION

This invention relates to optical switches in general, and more particularly to methods and apparatus for providing sparing capacity in optical switches.

### BACKGROUND OF THE INVENTION

In their simplest form, optical switches typically include a mirror for selectively directing an input signal supplied at an input port to a desired output port and, in practice, generally comprise an array of such mirrors for selectively directing a plurality of input signals to appropriate output ports.

The term “optical fabric” is sometimes used to refer to the portion of a switch incorporating the aforementioned mirrors.

A problem arises when one or more of the mirrors fails to operate, either at the point of manufacture or after it is incorporated into a product. Often, optical fabrics do not fail in their entirety: only individual or grouped portions of the optical fabric will fail. Unfortunately, however, it is frequently impossible to predict where the failure will occur when a fabric is initially manufactured or deployed. Accordingly, a flexible manner for correcting these failures is desired.

### SUMMARY OF THE INVENTION

As a result, one object of the present invention is to provide a flexible manner for correcting the aforementioned failures in the optical fabric of a switch.

Another object of the present invention is to provide additional capacity at the fabric level of the optical switch to account for element failures over time.

Still another object of the present invention is to provide a method and apparatus for sparing design optimization to solve sparing problems.

Yet another object of the present invention is to provide a method and apparatus for sparing design optimization comprising internal sparing allocation for improving manufacturing yields.

And another object of the present invention is to provide a method and apparatus for sparing design optimization comprising external sparing allocation for improving manufacturing yields.

Still another object of the present invention is to provide a method and apparatus for sparing design optimization comprising spare utilization before failure occurs.

Yet another object of the present invention is to provide a method and apparatus for sparing design optimization comprising a manual method for re-routing to spares.

And another object of the present invention is to provide a method and apparatus for sparing design optimization comprising an automatic method for re-routing to spares.

Still another object of the present invention is to provide a method and apparatus for sparing design optimization to solve sparing problems which involve handling adjacent mirror failures.

Yet another object of the present invention is to provide a method and apparatus for sparing design optimization comprising a main fabric and a smaller sparing fabric.

With these and other objects in view, there is provided apparatus for providing sparing capacity for an optical switch, the apparatus comprising: a set of primary mirrors selectively configurable within the optical switch so as to selectively faciliate a plurality of optical connections thereacross; and at least one secondary mirror selectively configurable within the optical switch so as to selectively facilitate at least one spare optical connection thereacross for replacement of at least one of the plurality of optical connections.

In another aspect of the invention, there is provided a method for providing sparing capacity for an optical switch, the method comprising: substituting one of at least one spare optical connection selectively facilitated across at least one secondary mirror for one of a plurality of optical connections selectively facilitated across a set of primary mirrors so as to provide sparing capacity for the one of the plurality of optical connections selectively facilitated across the set of primary mirrors.

In another aspect of the invention, there is provided apparatus for allocation of sparing capacity in an optical switch, the apparatus comprising an optical data signal received at an input port of the switch for transmission through the optical switch; a first mirror selectively positionable relative to the optical data signal so as to facilitate an optical connection through the optical switch, a second mirror selectively positionable relative to another optical data signal so as to facilitate an additional optical connection through the optical switch, and a third mirror selectively positionable relative to a spare input port; a first mirror control circuit in electrical connection with the first mirror and receiving feedback related to the optical connection so as to facilitate the optical connection through the optical switch, a second mirror control circuit in electrical connection with the second mirror and receiving feedback related to the additional optical connection so as to facilitate the additional optical connection through the optical switch, and a third mirror control circuit in electrical connection with the third mirror and receiving feedback related to a spare optical connection so as to selectively facilitate the spare optical connection through the optical switch; and re-routing means for reconfiguring the optical data signal from the input port to the spare input port so as to facilitate the spare optical connection through the optical switch using the third mirror.

In accordance with a further feature of the invention, there is provided a method for allocation of sparing capacity in an optical switch, the method comprising: monitoring an optical data signal being transmitted across a mirror through the optical switch; detecting a failed connection of the optical data signal across the mirror through the optical switch; and re-routing the optical data signal from the failed connection across the mirror to a spare mirror so as to provide a spare connection through the optical switch.

### BRIEF DESCRIPTION OF THE DRAWINGS

These and other objects and features of the present invention will be more fully disclosed by the following detailed description of the preferred embodiments of the invention, which is to be considered together with the accompanying drawings wherein like numbers refer to like parts and further wherein:

FIGS. 1-3 are schematic views of an internal fabric sparing allocation system which comprises one embodiment of the present invention;

FIGS. 4-6 are schematic views of an external fabric sparing allocation system which comprises another embodiment of the present invention;

FIG. 7 is a schematic view of an external fabric sparing allocation system which comprises another embodiment of the present invention;

FIGS. 8 and 9 are schematic views of a flexible optical interconnect which comprises another embodiment of the present invention, with the system being configured to manually route around a failure; and

FIGS. 10-14 are schematic views of an optical switch system which comprises another embodiment of the present invention, with the system being configured to automatically re-route an optical path around a failure that occurs therein.

### DETAILED DESCRIPTION OF THE PREFERRED EMBODIMENTS

Referring to FIGS. 1-3, there is shown an internal fabric sparing allocation system 5 for improving manufacturing yields. More particularly, internal fabric sparing allocation system 5 comprises a switch fabric 10 having a plurality of mirrors 15A, 15B, 15C, etc. These mirrors 15A, 15B, 15C, etc. are designed to receive input signals provided by fibers 20A, 20B, 20C, etc., respectively, and collimated by collimator lenses 25A, 25B, 25C, etc., respectively, and direct those input signals to appropriate output ports as light beams 30A, 30B, 30C, etc., respectively. Mirror control circuits 35A, 35B, 35C, etc. control operation of mirrors 15A, 15B, 15C, etc., respectively.

With this form of the invention, extra mirrors are provided for use as spares. Electrical control (i.e., appropriate mirror control circuits 35A, 35B, 35C, etc.) is preferably provided for all of the mirrors 15A, 25B, 15C, etc. in fabric 10, but fiber-collimator connections are allocated only to mirrors that are known to be operational (i.e., only to mirrors that have previously passed a manufacturing test).

Thus, for example, where the switch fabric 10 comprises a strip of four mirrors 15A-15D, and if the statistical manufacturing data shows that no more than one of the mirrors 15A-15D would be likely to fail within the manufacturing process, then three fibers 20A-20C should be the maximum safe allocation toward each group of four mirrors 15A-15D. The mirrors in fabric 10 would be tested, the operational mirrors noted, and then a fiber-mirror connection map generated to allocate three fibers 20A-20C to an appropriate group of three mirrors in fabric 10. For example, where mirrors 15A, 15B and 15C are all operating properly, fibers 20A, 20B and 20C might be mapped to mirrors 15A, 15B and 15C, respectively. In this case, mirror control circuits 35A-35C appropriately control mirrors 15A-15C as working mirrors, while mirror control circuit 35D controls mirror 15D as an idle mirror (FIG. 1).

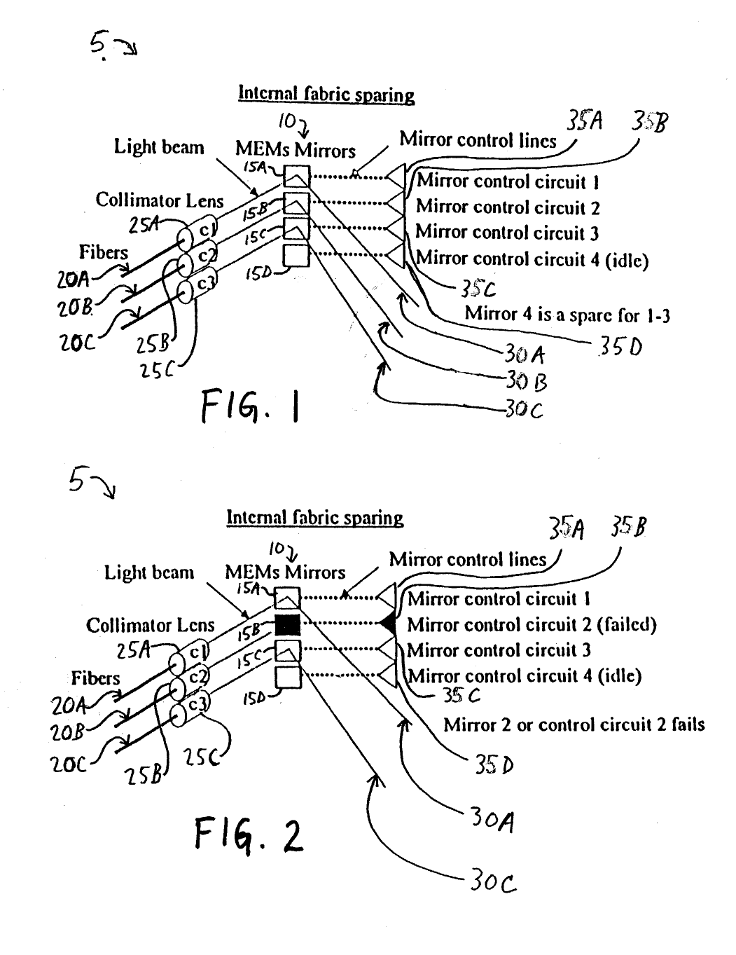

Looking now at FIG. 2, it might occur that one of the working mirrors 15A-15C might fail, or one of the associated mirror control circuits 35A-35C might fail. By way of example, as seen in FIG. 2, mirror 15B and/or mirror control circuit 35B might fail.

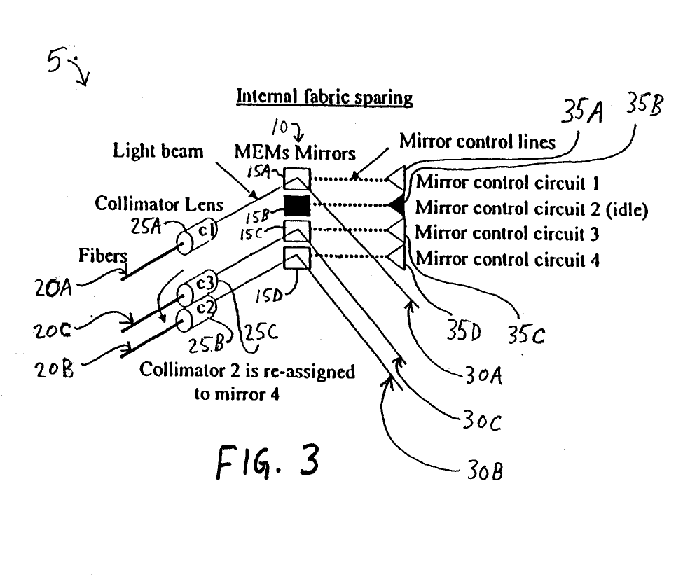

In this case, and looking now at FIG. 3, fiber 20B and collimator lens 25B could be reassigned to mirror 15D. This might involve creating a new fiber-mirror connection map to reflect this new assignment of fiber 20B to mirror 15D. In other words, fiber 20B and collimator lens 25B are re-assigned to mirror 15D, which is controlled by mirror control circuit 35D. As a result, the data in fiber 20B will once again be properly transmitted through switch fabric 10, despite the failure of mirror 15B and/or mirror control circuit 35B.

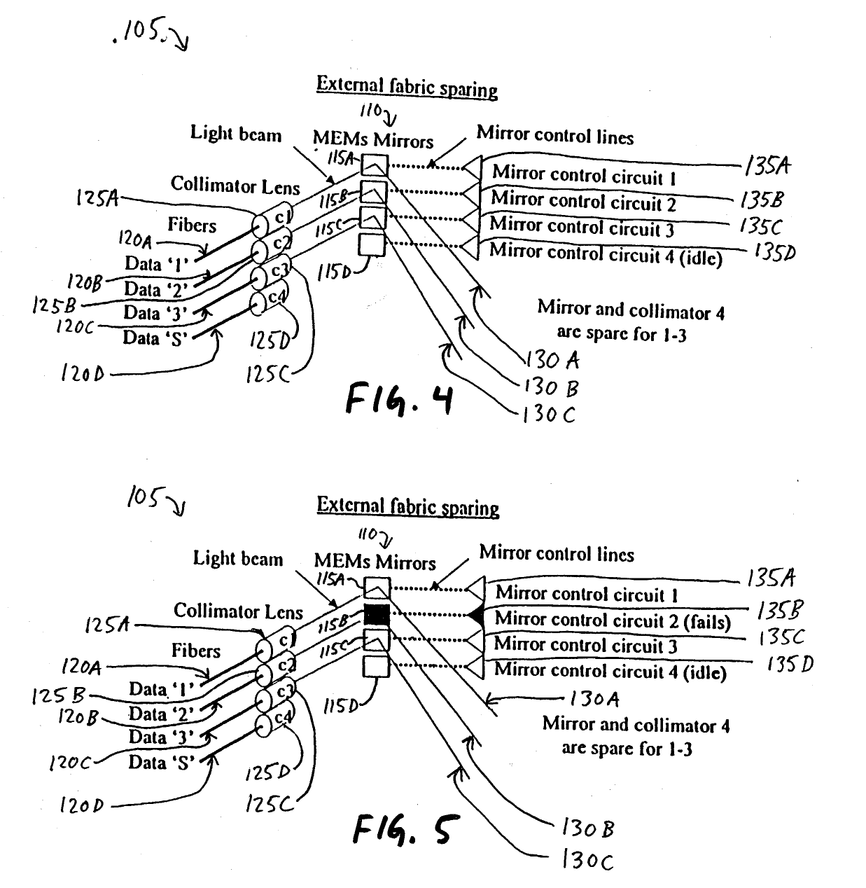

Looking now at FIGS. 4-6, there is shown an external fabric sparing allocation system 105 for improving manufacturing yields. More particularly, external fabric sparing allocation system 105 comprises a switch fabric 110 having a plurality of mirrors 115A, 115B, 115C, etc. These mirrors 115A, 115B, 115C, etc. are designed to receive input signals provided by fibers 120A, 120B, 120C, etc., respectively, and collimated by collimator lenses 125A, 125B, 125C, etc., respectively, and direct those input signals to appropriate output ports as light beams 130A, 130B, 130C, etc., respectively. Mirror control circuits 135A, 135B, 135C, etc. control operation of mirrors 115A, 115B, 115C, etc., respectively.

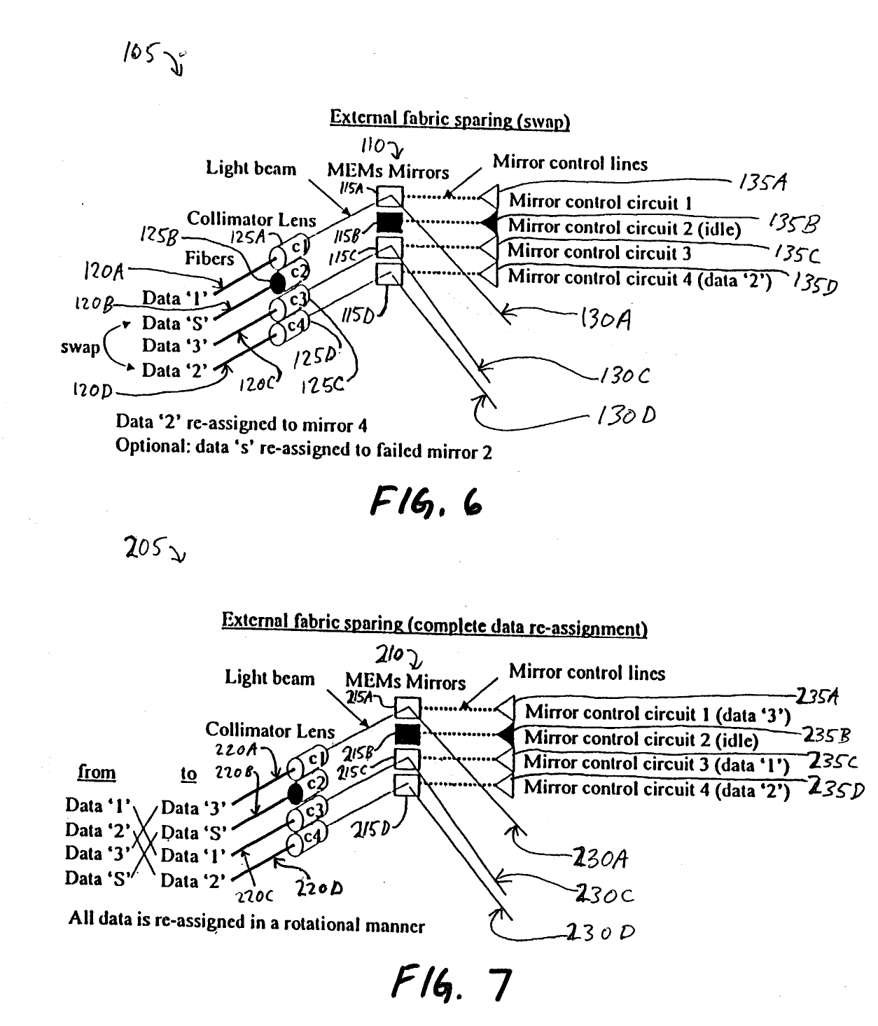

With this form of the invention, only a subset of the mirrors in switch fabric 110 is used for normal traffic and the remaining (i.e., unused) mirrors of the superset are used for spare traffic. For example, if switch fabric 110 comprises a strip of four mirrors 115A-115D, and if manufacturing data shows that no more than one mirror could fail statistically within the manufacturing process, then only three fibers should be counted on for long-term availability for making connections. Thus, for example, if there are no manufacturing failures for a particular system 105, the four electrical drivers 135A-135D operate the three mirrors 115A-115C for normal traffic on fibers 120A-120C, respectively, and hold one mirror 115D as a spare (FIG. 4). If there is a mirror failure, e.g. mirror 115B (FIG. 5), data is swapped off fiber 120B and onto fiber 120D, whereupon the three mirrors 115A, 115C and 115D are used for traffic and the mirror 115B is idle (FIG. 6). As a result, the data previously transmitted in fiber 120B will once again be properly transmitted through switch fabric 110, despite the failure of mirror 115B.

Referring now to FIG. 7, there is shown an external fabric sparing allocation system 205. More particularly, external fabric sparing allocation system 205 comprises a switch fabric 210 having a plurality of mirrors 215A, 215B, 215C, etc. These mirrors 215A, 215B, 215C, etc. are designed to receive input signals provided by fibers 220A, 220B, 220C, etc., respectively, and collimated by collimator lenses 225A, 225B, 225C, etc., respectively, and direct those input signals to appropriate output ports as light beams 230A, 230B, 230C, etc., respectively. Mirror control circuits 235A, 235B, 235C, etc. control operation of mirrors 215A, 215B, 215C, etc., respectively.

With this form of the invention, if switch fabric 210 comprises a strip of four mirrors 215A-215D, and if statistical data indicates that only one mirror is likely to fail over some target time period, then only three fibers should be counted on for making connections. Thus, for example, the four electrical drivers 235A-235D might operate the three mirrors 215A-215C for normal traffic on fibers 220A-220C, and hold mirror 215D (and fiber 220D) as a spare. However, if a failure occurs, the system can be configured to effect complete data re-assignment.

In other words, suppose mirror 215B should fail. Rather than swapping only data line ‘2’ (which is the data in fiber 220B being directed through mirror 215B) with data line ‘S’ (which is the data in fiber 220D being directed through mirror 215D), such as is the case with the system of FIG. 6, all of the data lines in the system of FIG. 7 may be re-assigned, such that data line ‘S’ is repositioned at the failed mirror 215B.

In one embodiment of the present invention, the data lines may be re-assigned by indexing each of the data lines “upward” until the data line ‘S’ is positioned at the failed mirror 215B, such as is shown in FIG. 7.

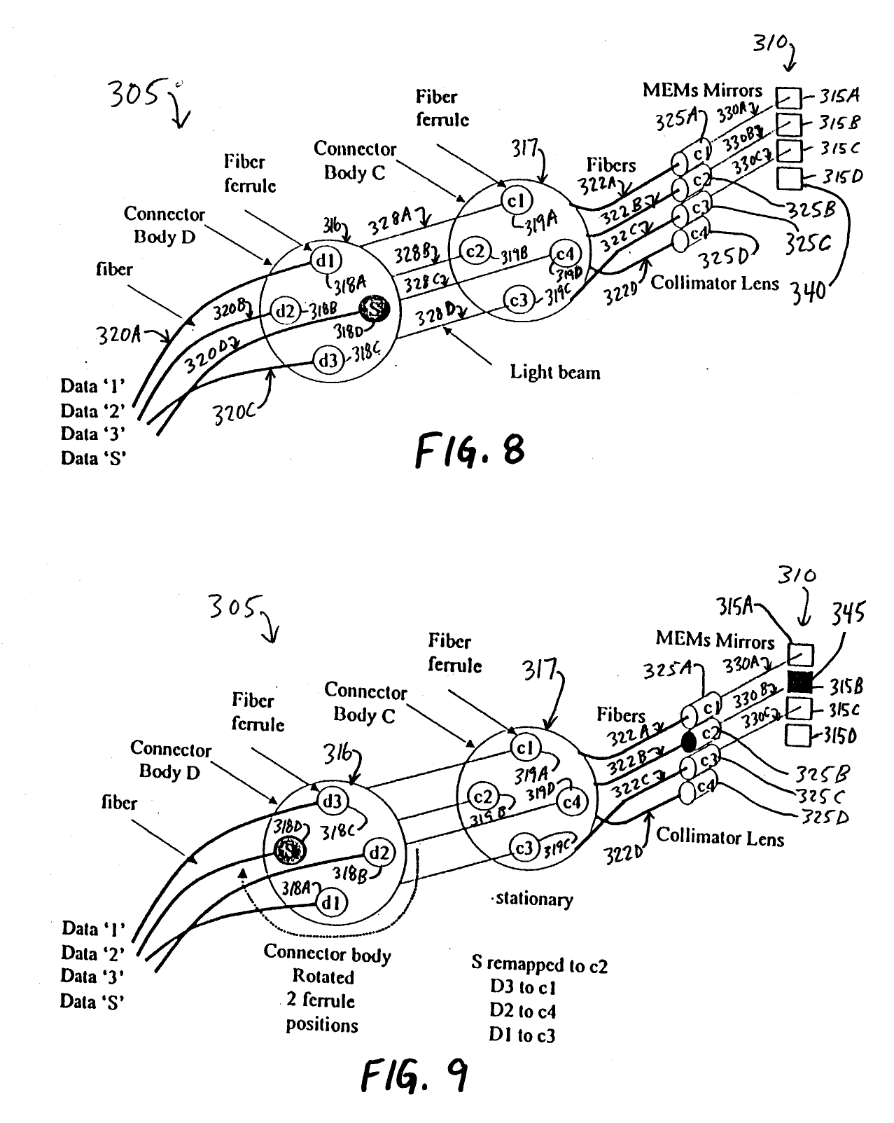

Looking next at FIGS. 8 and 9, there is shown an optical interconnect 305 which may be used to sequentially index the data lines so as to manually route around a failure. Optical interconnect 305 is also sometimes referred to as rotary connector 305 herein. Manual routing around failures is beneficial in that the location of an impending failure may not be known. While optical interconnect 305 may be configured for different numbers of lines, it will herein be discussed in the context of three active data lines and one spare data line.

More particularly, as seen in FIGS. 8 and 9, fabric 310 has a strip of four mirrors 315A-315D. Optical interconnect 305 includes a first connector body 316 and a second connector body 317. First connector body 316 and second connector body 317 are rotatably adjustable with respect to one another; preferably first connector body 316 is rotable and second connector body 317 is stationary. First fiber ferrules 318A-318D are disposed within first connector body 316. Second fiber ferrules 319A-319D are disposed within second connector body 317. Input fibers 320A-320D have an end in connection with first fiber ferrules 318A-318D, respectively. Output fibers 322A-322D have a first end in connection with second fiber ferrules 319A-319D, respectively, and a second end in connection with collimator lenses 325A-325D, respectively. Light beams 328A-328D are emitted from first fiber ferrules 318A-318D, respectively. Light beams 328A-328D are received by second fiber ferrules 319A-319D, according to the alignment of first fiber ferrules 318A-318D with second fiber ferrules 319A-319D (i.e., according to the angular position of first connector body 316 relative to second connector body 317). Light beams 330A-330C (corresponding to three active data lines) are emitted from collimators 325A-325C for connection through mirrors 315A-315C, respectively.

Still looking at FIGS. 8 and 9, with optical connector 305, the optical connections N are flexibly allocated to N out of N+M points, with M being the additional sparing capacity of optical fabric 310. The specific example illustrated in FIGS. 8 and 9 illustrates the case where N=3 and M=1.

When a failure occurs in the fabric 310, the number of connections (N=3) must be re-allocated to a minimum of N non-failed elements. This is accomplished by rotating first connector body 316 with respect to second connector body 317 so as to redistribute (i.e., re-arrange) the input connections (N=3) to available “non-failed” elements (N=3). In other words, the connections are redistributed around the failed element. Once this is accomplished, the interconnect mapping, which is also referred to as connection memory, is updated due to the new re-arrangement.

By way of example, suppose the system is configured in the manner shown FIG. 8, i.e., so that data line ‘1’, data line ‘2’ and data line ‘3’ are directed through mirrors 315A-315C, respectively, and suppose that mirror 315B should fail. Then first connector body 316 is indexed two positions, so that data line ‘1’, data line ‘2’ and data line ‘3’ are directed through mirrors 315C, 315D and 315A, respectively, in the manner shown in FIG. 9.

The system shown in FIGS. 8 and 9 is beneficial in that it provides a flexible interconnect which is more compact and “in-service practical” than individual interconnects per fiber, which are hard to manage at a high-density level. This high-density issue is a significant one for large scale cross-connects (such as 256 lines and higher). It can also be a significant issue with small, compact designs with smaller numbers of lines (such as 256 and below).

Another benefit of using the approach of FIGS. 8 and 9 is that angled ferrules 318A-318D and 319A-319D can still be used for each interconnect point, and still achieve ultra-low return loss. Of course, the ferrule angles must reference the center rotation point of the multi-connector body.

If redundant switch fabrics 310 are deployed in a system design, the present invention will allow “in-service” repair, such that traffic is supported on another one of the cores during the failure. Once the failure is repaired within the core that had the failure, or routed therearound, switch redundancy is restored.

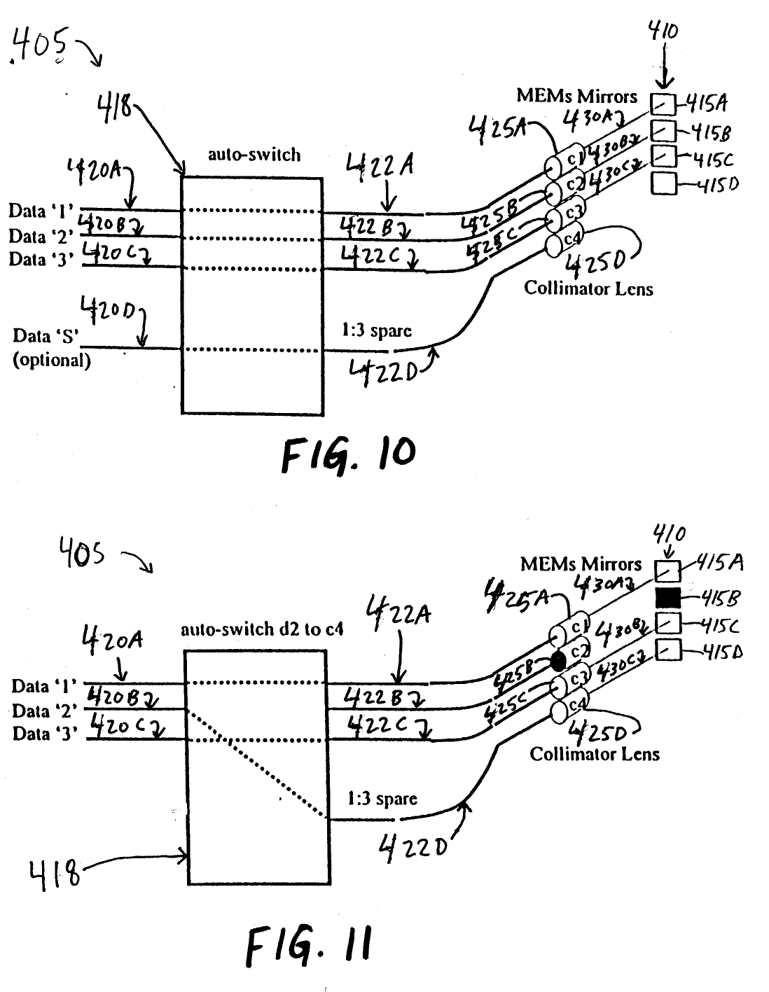

Referring now to FIGS. 10-14, there are shown optical switch systems 405, 505 to automatically re-route an optical path around a failure that occurs therein. Here, N ports are reallocated across N+M ports. The N+M ports are the direct interconnect points to an optical fabric 410, 510. If one element fails with the N+M capacity, the N ports are automatically routed around the “up to M” failure(s).

Looking now at FIGS. 10 and 11, that is shown optical switch system 405 which comprises an auto-switch 418 which is in optical connection with input fibers 420A-420D so as to receive signals therefrom. Output fibers 422A-422D each have (1) a first end in optical connection with auto-switch 418 so as to receive signals from input fibers 420A-420D as selectively directed by auto-switch 418, and (2) a second end in optical connection with collimator lenses 425A-425D, respectively. Light beams 430A-430C are selectively emitted from one of collimator lenses 425A-425D for connection through a corresponding one of mirrors 415A-415D, respectively.

Optical switch system 405 has the ability to route around a mirror failure. More particularly, suppose the system is initially configured so that data lines ‘1’, ‘2’ and ‘3’ are directed through mirrors 415A, 415B and 415C. Suppose further that mirror 415B fails. In this case, auto-switch 418 can be reconfigured to direct data ‘2’ to output fiber 422D and hence mirror 415D (FIG. 11).

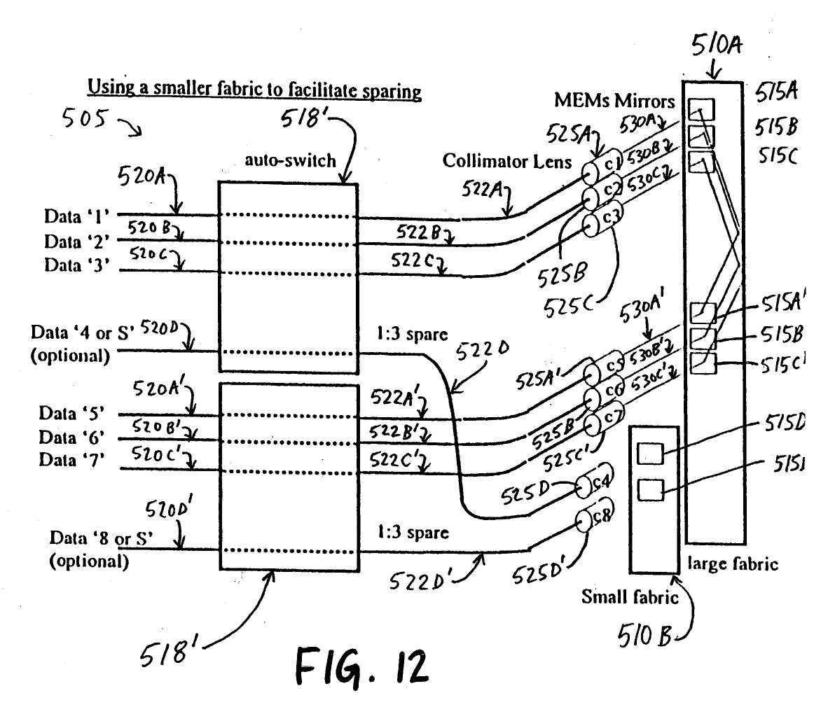

Referring next to FIGS. 12-14, there is shown an optical switch system 505 having a first switch fabric 510A and a second switch fabric 510B. First switch fabric 510A includes a first set of mirrors 515A-515C and mirrors 515A′-515C′ that correspond to one another, respectively. Second switch fabric 510B includes a second set of mirrors 515D and 515D′ that correspond to one another. In a preferred embodiment of the present invention, first switch fabric 510A is sized larger than second switch fabric 510B. In another preferred embodiment of the present invention (not shown), second switch fabric 510 is sized equal to, or larger than, first switch fabric 510A. This allows for manual or automatic sparing operations to occur more efficiently and practically by distributing the adjacent failures outside of a single connector, entity, or switch fabric 510A, 510B.

A first auto-switch 518 and a second auto-switch 518′ are in optical connection with first external fibers 520A-520D and second external fibers 520A′-520D′, respectively, so as to transmit and/or receive signals therefrom. First internal fibers 522A-522D and second internal fibers 522A′-522D′ each have (1) a first end in optical connection with first auto-switch 518 and second auto-switch 518′, respectively, so as to transmit signals to, and/or receive signals from, external fibers 520A-520D and external fibers 520A′-520D′ as selectively directed by first auto-switch 518 and second auto-switch 518′, respectively; and (2) a second end in optical connection with collimator lenses 525A-525D and collimator lenses 525A′-525D′, respectively. Light beams 530A-530D and light beams 530A′-530D′ are selectively transmitted through collimators 525A-525D and through collimators 525A′-525D′ so as to form a connection through large fabric 510A. More particularly, auto-switch 518 and 518′, and mirrors 515A-515C and 515A′-515C′, permit data line ‘1’ to be connected to data line ‘5’, and data line ‘2’ to be connected to data line ‘6’, and data line ‘3’ to be connected to data line ‘7’ (FIG. 12).

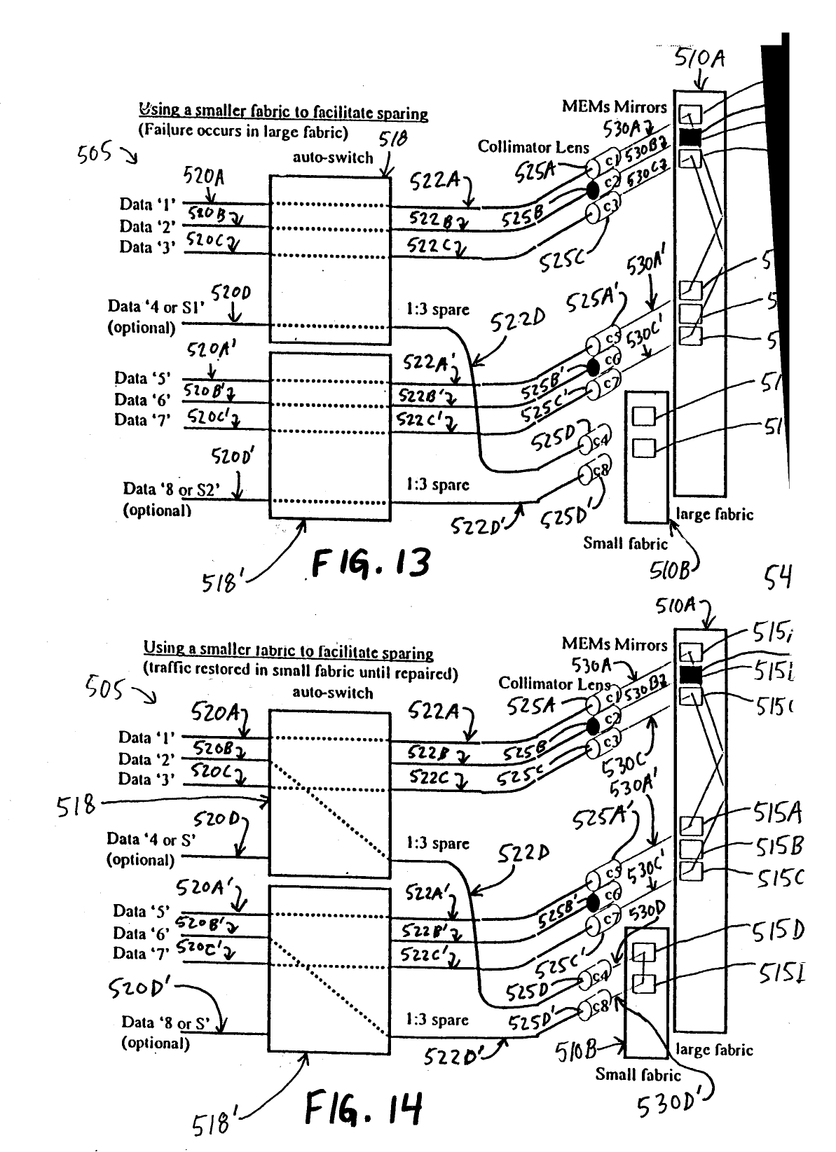

However, if, for example, mirror 515B or mirror 515B′ should fail, data line ‘2’ will not be connected to data line ‘6’ (FIG. 13).

However, auto-switches 518 and 518′, and second switch fabric 510B, will permit a repair connection to be made. This is done by routing data line ‘2’ through output fiber 522D, across mirrors 515D and 515D′, out fiber 522D′, and out data line ‘6’.

Significantly, this repair connection can be made using relatively small fabric 510B compared to the large scale fabric 510A. For example, in the configuration shown in FIGS. 12-14, the large fabric is sized N×N and the smaller fabric is sized N/3×N/3. In other words, the small fabric is one-third the size of the larger core.

The preferred embodiments of the present invention as shown and described herein are related to MEM's based optical switch fabrics. It should, of course, be appreciated that the present invention is by no means limited to the particular constructions and method steps disclosed above and/or shown in the drawings, but also comprises any modifications or equivalents within the scope of the claims, which include, but are not limited to, optical beam steering designs, moving collimator designs, and electrical fabric designs.

What is claimed is:

1. Apparatus for providing sparing capacity for an optical switch, said apparatus comprising:
a set of primary mirrors selectively configurable within said optical switch so as to selectively facilitate a plurality of optical connections thereacross; and
at least one secondary mirror selectively configurable within said optical switch so as to selectively facilitate at least one spare optical connection thereacross for replacement of at least one of said plurality of optical connections.

2. Apparatus according to claim 1 wherein there is provided a first quantity of mirrors for said set of primary mirrors, a second quantity of mirrors for said at least one secondary mirror, said first quantity being greater than said second quantity.

3. Apparatus according to claim 1 further comprising additional apparatus for manipulation of one of said at least one spare optical connection selectively facilitated across said at least one secondary mirror in order to substitute said one of said at least one spare optical connection for one of said plurality of optical connections selectively facilitated across said set of primary mirrors so as to provide sparing capacity for said one of said plurality of optical connections selectively facilitated across said set of primary mirrors.

4. Apparatus according to claim 2 wherein said apparatus for manipulation comprises at least one mirror control circuit, one of said at least one mirror control circuit in operable connection with one of said at least one secondary mirror, said one of said at least one said mirror control circuit receiving feedback related to said one of said at least one spare optical connection thereacross so as to maintain said one of said at least one spare optical connection across said at least one secondary mirror.

5. Apparatus according to claim 1 further comprising mirror control circuits in operable connection with said set of primary mirrors, said mirror control circuits receiving feedback related to said plurality of optical connections thereacross so as to maintain each of said plurality of optical connections across said set of primary mirrors.

6. Apparatus according to claim 1 wherein said set of primary mirrors comprises a first primary mirror input fiber and a second primary mirror input fiber corresponding to a first one of said set of primary mirrors and a second one of said set of primary mirrors, respectively.

7. Apparatus according to claim 6 further comprising additional apparatus for manipulation of one of said at least one spare optical connection selectively facilitated across said at least one secondary mirror in order to substitute said at least one spare optical connection for one of said plurality of optical connections selectively facilitated across said set of primary mirrors, wherein said additional apparatus for manipulation comprise means for reassigning said first primary mirror input fiber from said first one of said set of primary mirrors to one of said at least one secondary mirror.

8. Apparatus according to claim 6 further comprising a secondary mirror input fiber corresponding to one of said at least one secondary mirror.

9. Apparatus according to claim 8 further comprising additional apparatus for manipulation of one of said at least one spare optical connection selectively facilitated across said at least one secondary mirror in order to substitute said at least one spare optical connection for one of said plurality of optical connections selectively facilitated across said set of primary mirrors, wherein said additional apparatus for manipulation comprise means for reassigning data from said first primary mirror input fiber to said secondary mirror input fiber.

10. Apparatus according to claim 9 further comprising a flexible optical interconnect having a first connector body and a second connector body, said first connector body comprising an end of a first connector body input fiber, an end of a second connector body input fiber, and an end of a third connector body input fiber, each of said first connector body input fiber, said second connector body input fiber, and said third connector body input fiber being flexibly connectable to one of said first primary mirror input fiber, said second primary mirror input fiber, and said secondary mirror input fiber, respectively, and said second connector body comprising a first end of said first primary mirror input fiber, a first end of said second primary mirror input fiber, and a first end of said secondary mirror input fiber, wherein said first connector body and said second connector body are rotatably adjustable with respect to one another so as to flexibly reassign data provided by said first connector body input fiber from said first primary mirror input fiber to at least one of said second primary mirror input fiber and said secondary mirror input fiber.

11. Apparatus according to claim 9 further comprising an auto-switch having a set of input ports and a set of output ports, said set of input ports and said set of output ports being selectively assignable to one another for optical connection through said auto-switch, said set of input ports being in optical connection with each of a first auto-switch input fiber, a second auto-switch input fiber, and a third auto-switch input fiber, and said set of output ports being in optical connection with each of said first primary mirror input fiber, said second primary mirror input fiber, and said secondary mirror input fiber, wherein at least a portion of said set of input ports and at least a portion of said set of output ports are reassigned to one another so as to flexibly reassign data provided by said first auto-switch input fiber from said first primary mirror input fiber to at least one of said second primary mirror input fiber and said secondary mirror input fiber.

12. Apparatus according to claim 11 further comprising a first fabric and a second fabric, said first fabric comprising said set of primary mirrors, and said second fabric comprising said at least one secondary mirror.

13. Apparatus according to claim 1 further comprising a first fabric and a second fabric, said first fabric comprising said set of primary mirrors, and said second fabric comprising said at least one secondary mirror.

14. A method for providing sparing capacity for an optical switch, said method comprising:
substituting one of at least one spare optical connection selectively facilitated across at least one secondary mirror for one of a plurality of optical connections selectively facilitated across a set of primary mirrors so as to provide sparing capacity for said one of said plurality of optical connections selectively facilitated across said set of primary mirrors.

15. A method according to claim 14 wherein there is provided a first quantity of mirrors for said set of primary mirrors, a second quantity of mirrors for said at least one secondary mirror, said first quantity being greater than said second quantity.

16. A method according to claim 14 further comprising the steps of monitoring each of said plurality of optical connections across said set of primary mirrors and detecting a failed one of said connections selectively facilitated across a failed mirror of said set of primary mirrors.

17. Apparatus for allocation of sparing capacity in an optical switch, said apparatus comprising:
an optical data signal received at an input port of said switch for transmission through said optical switch;
a first mirror selectively positionable relative to said optical data signal so as to facilitate an optical connection through said optical switch, a second mirror selectively positionable relative to another optical data signal so as to facilitate an additional optical connection through said optical switch, and a third mirror selectively positionable relative to a spare input port;
a first mirror control circuit in electrical connection with said first mirror and receiving feedback related to said optical connection so as to facilitate said optical connection through said optical switch, a second mirror control circuit in electrical connection with said second mirror and receiving feedback related to said additional optical connection so as to facilitate said additional optical connection through said optical switch, and a third mirror control circuit in electrical connection with said third mirror and receiving feedback related to a spare optical connection so as to selectively facilitate said spare optical connection through said optical switch; and
re-routing means for reconfiguring said optical data signal from said input port to said spare input port so as to facilitate said spare optical connection through said optical switch using said third mirror.

18. Apparatus according to claim 17 wherein said re-routing means comprise means for relocating said first input fiber from said first input port to said spare input port.

19. Apparatus according to claim 17 further comprising a third input fiber located at said spare input port, and wherein said re-routing means comprise means for relocating said optical data signal from said first input fiber to said third input fiber.

20. Apparatus according to claim 17 further comprising a flexible optical interconnect having first and second bodies interposed between first and second portions of said first input fiber, said second input fiber, and said third input fiber, respectively, and at least one of said first and second bodies being rotatable with respect to the other one, wherein said re-routing means comprise means for rotating said at least one of said first and second bodies with respect to the other one.

21. Apparatus according to claim 17 further comprising an auto-switch being interposed between first and second portions of said first input fiber and said second input fiber, respectively, said auto-switch having at least a portion of said third input fiber optically connected thereto, and said auto-switch being in electrical connection with each of said first mirror control circuit, said second mirror control circuit, and said third mirror control circuit so as to automatically reconfigure said optical data signal from said first portion of said first input fiber to said third input fiber, wherein said re-routing means comprise said auto-switch.

22. Apparatus according to claim 21 wherein said auto-switch is interposed between first and second portions of said third input fiber.

23. Apparatus according to claim 21 further comprising an additional auto-switch interposed between first and second portions of a first output fiber, a second output fiber, and a third output fiber, respectively, a fourth mirror selectively positionable relative to said first output fiber, a fifth mirror selectively positionable relative to said second output fiber, and a sixth mirror selectively positionable relative to said third output fiber, said additional auto-switch being in electrical connection with a fourth control circuit for said fourth mirror, a fifth control circuit for said fifth mirror, and a sixth control circuit for said sixth mirror, so as to automatically reconfigure said optical data signal through said auto-switch and said additional auto-switch from said first and second portions of said first input fiber through said first and second portions of said first output fiber to said first portion of said first input fiber through said second portion of said third input fiber, across said third mirror and said sixth mirror, and said first portion of said third output fiber and said second portion of said first output fiber.

24. Apparatus according to claim 23 further comprising a large fabric and a small fabric, said large fabric having said first mirror, said second mirror, said fourth mirror, and said fifth mirror thereon, and said small fabric having said third mirror and said sixth mirror thereon.

25. Apparatus according to claim 17 further comprising a large fabric and a small fabric, said large fabric having said first mirror and said second mirror thereon, and said small fabric having said third mirror thereon.

26. Apparatus according to claim 17 further comprising a first collimator lens located along a pathway of said optical data signal between said first mirror said input port, and a second collimator lens being located along a pathway of said additional optical connection between said second mirror and an input port at an end of said second input fiber.

27. Apparatus according to claim 26 further comprising a third collimator lens located along a pathway of said spare optical connection between said third mirror and said spare input port.

28. Apparatus according to claim 17 wherein said third mirror is idle prior to re-routing one of said optical signal and said additional optical signal thereto.

29. Apparatus according to claim 17 further comprising detection means for determining operability of said optical connection, said detection means being in electrical connection with said first mirror control circuit, wherein said detection means signal said re-routing means to selectively indicate a failed connection through one of said first mirror.

30. Apparatus according to claim 17 wherein said detection means signal said re-routing means to selectively indicate an idle connection across said third mirror.

31. Apparatus according to claim 17 wherein each of said first mirror, said second mirror and said third mirror comprises a MEM's mirror.

32. A method for allocation of sparing capacity in an optical switch, said method comprising:
monitoring an optical data signal being transmitted across a mirror through said optical switch;
detecting a failed connection of said optical data signal across said mirror through said optical switch; and
re-routing said optical data signal from said failed connection across said mirror to a spare mirror so as to provide a spare connection through said optical switch.

33. A method according to claim 32 further comprising the step of monitoring said mirror having said failed connection thereacross so as to determine a completion of repair to said failed connection.

34. A method according to claim 33 further comprising the step of re-routing said optical data signal from said spare connection to said mirror so as to re-establish said optical data connection.
